(19) United States
(12) Patent Application Publication
(10) Pub. No.: US 2011/0078704 A1
(43) Pub. Date: Mar. 31, 2011

(54) ASPECT-ORIENTED COMPLEX EVENT PROCESSING SYSTEM AND ASSOCIATED METHOD

(75) Inventors: Orem MISHALI, Haifa (IL); Shmuel Katz, Haifa (IL)

(73) Assignee: TECHNION RESEARCH AND DEVELOPMENT FOUNDATION LTD., Haifa (IL)

(21) Appl. No.: 12/569,736

(22) Filed: Sep. 29, 2009

(51) Int. Cl. G06F 9/46

(52) U.S. Cl. 719/318

(57) ABSTRACT

A system and method for aspect-oriented complex event processing is presented for monitoring simple events occurring in a base system, identifying sequences of events which indicate the occurrence of a complex events and acting upon them. Embodiments of the invention may be applicable for monitoring in a variety of applications such as in software engineering, fraud detection, population monitoring and medical care.

### FIELD OF THE INVENTION

The present invention relates to complex event processing systems. In particular, the invention relates to aspect-oriented implementations of complex event processing.

### BACKGROUND OF THE INVENTION

During the operation of any system multiple events occur. It is often possible to identify meaningful event sequences from which inferences may be made. For example, consider three simple events: (i) a whistle blowing, (ii) a crowd cheering and (iii) a cup being lifted. Each of these individual events, taken by itself, may indicate various situations. In combination, however, the event sequence may be used to infer that some single sporting competition has occurred. Such inferences, which are based upon sequences of simple events, are termed complex events.

Complex Event Processing (CEP) is an event processing concept which deals with the processing of simple events with the goal of identifying meaningful event sequences indicating the occurrence of complex events. CEP is extremely useful in a variety of applications including, but not limited to, examples such as stock trading, credit card fraud detection, business activity tracking, population monitoring, security tracking, medical monitoring and the like.

Although CEP may be of much use in tracking software systems, it is surprisingly difficult to implement CEP on top of preexisting software systems. A block diagram schematically representing a typical PRIOR ART Complex Event Processing system is shown in FIG. 1, where the system 10 is configured to process events generated by a base system 20. It is noted that the PRIOR ART CEP system 10 includes a number of separate software components, notably an event-tracker 12 and an event-processor 14.

The role of the event-tracker 12 is to identify simple events 2 occurring in the base system and pass these on to the event-processor 14. The event-processor 14 then searches for meaningful sequences of simple events indicating the occurrence of complex events 4. The event-processor 14 may also provide a mechanism for reacting to the identification of complex events 4.

Aspect-Oriented Programming (AOP) is a programming paradigm which extends Object-Oriented Programming (OOP) by allowing the separation of cross-cutting concerns. Aspect-Oriented Programming (AOP) techniques may be used to identify simple events occurring in the base system. For example, a programmer may use AspectJ, which is an AOP language which extends the Object-Oriented Programming language Java. In AspectJ, constructs known as aspects contain several entities unavailable to standard classes. In particular, aspects may include pointcut expressions and advice expressions. Pointcut expressions specify points during the execution of a base program and advice expressions specify code to run at the execution point matched by a pointcut.

Although AspectJ pointcuts may be used to identify simple events occurring during the operation of a program, occurrences of complex events are much more difficult to detect. It is a known limitation of AspectJ and similar languages that pointcuts relate to a specific execution point in the program and thus AspectJ is not capable of naturally expressing high-level events that are the culmination of a series of more basic events.

The need remains, therefore, for an aspect-based complex event processing system capable of identifying the occurrence of complex events during operation of a base system. Embodiments of the present invention address this need.

### SUMMARY OF THE EMBODIMENTS

Embodiments the present invention relate to a complex event processing system comprising at least one storage medium containing code operable to identify complex events occurring in a base system, wherein the code is compiled from an aspect-oriented program. Typically, the code includes at least one event-aspect and at least one response-aspect. Event-aspects may be configured to identify the occurrence of at least one event. Response-aspects may be configured to operate upon the event-aspect and may be further configured to notify of the occurrence of the event.

According to particular embodiments, the system further comprises an event repository for storing at least one section of code corresponding to at least one event-aspect. The section of code typically includes at least one event-aspect and at least one response-aspect. Optionally, at least one event-aspect may comprise at least one section of code retrieved from the event repository. Optionally, again, at least one response-aspect comprises at least one section of code retrieved from the event repository.

Variously, in embodiments of the system, the base system is selected from a group consisting of: distributed information technology systems, banking systems, stock trading systems, software development systems, fraud detection systems, security systems, population monitoring systems, medical systems and the like.

Another aspect of the invention is to teach a method for identifying complex event occurring in a base system the method comprising the steps: step (a)—compiling an aspect-oriented program comprising at least one event-aspect and at least one response-aspect; step (b)—the event-aspect identifying a sequence of simple events occurring during the operation of the base system; step (c)—the response-aspect responding to the event-aspect identifying the sequence of simple events.

Optionally, step (a) includes the substeps: step (a1)—providing an event repository for storing at least one section of code; step (a2)—composing aspect-oriented code, step (a5)—compiling aspect-oriented code and at least one of the additional substeps step (a3)—storing at least one section of the code in the event repository, and step (a4)—using at least one section of code retrieved from the event repository in at least one of an event-aspect or a response-aspect. Accordingly, at least one response-aspect or event-aspect may comprise at least one section of code retrieved from the event repository.

### BRIEF DESCRIPTION OF THE FIGURES

For a better understanding of the invention and to show how it may be carried into effect, reference will now be made, purely by way of example, to the accompanying drawings.

With specific reference now to the drawings in detail, it is emphasized that the particulars shown are by way of example and for purposes of illustrative discussion of the embodiments of the present invention only, and are presented for the purpose of providing what is believed to be the most useful and readily understood description of the principles and conceptual aspects of the invention. In this regard, no attempt is made to show structural details of the invention in more detail than is necessary for a fundamental understanding of the invention; the description, taken with the drawings, makes apparent to those skilled in the art how the several forms of the invention may be embodied in practice. In the accompanying drawings:

FIG. 1 is a block diagram schematically representing a typical PRIOR ART complex event processing system;

FIG. 2 is a block diagram representing the main elements of an aspect based complex event processing framework according to an embodiment of the invention;

FIG. 3 is a flowchart showing a method for identifying complex events according to embodiments of the invention;

FIG. 4 is a flowchart representing a typical development cycle for a software developer working in an extreme programming environment in which an illustrative embodiment of the system may be applied;

FIG. 5 shows a specification of one event-aspect as used in the illustrative embodiment;

FIG. 6 shows a code segment containing two JUnit methods for use in a low level event aspect of the illustrative embodiment, and

FIG. 7 shows another code segment of the high level event-aspect of the illustrative embodiment.

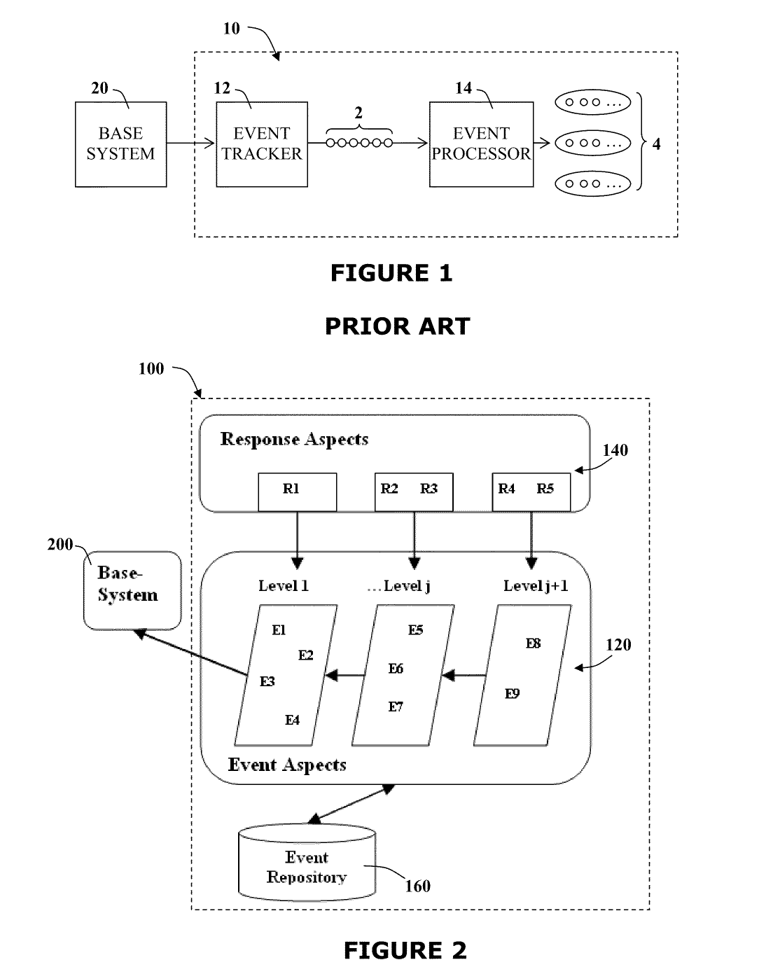

### DESCRIPTION OF EMBODIMENTS

Reference is now made to FIG. 2 showing a block diagram representing the main elements of a complex event processing (CEP) system 100 according to an exemplary embodiment of the invention. The event processing system 100 is configured to monitor a base system 200 and to identify complex events occurring during its operation.

The event processing system 100 is compiled from an aspect-oriented program and includes a set of event-aspects 120 and a corresponding set of response-aspects 140. In certain embodiments, an event repository 160 is provided to assist in the construction of the event processing system 100. The event repository 160 stores code segments corresponding to predefined event-aspects. Stored code segments may be used in the construction of new event-aspects and response-aspects. During construction of the new aspects, new code segments may be added to the event repository 160 as required for future use.

Each event-aspect E1-9 is configured to identify sequences of events representing complex events. When such event-sequences are identified the event-aspect typically notifies higher level event aspects and/or response aspects of the occurrence. Response-aspects R1-5 operate upon the event-aspects E1-9 and may be configured to take specific actions when particular complex events are identified.

It is a feature of the embodiment that event-aspects are nested, with multiple levels of event-aspects arranged in a hierarchical structure. For example, the event-aspects may be arranged into first level aspects E1-4, second level aspects E5-7 and third level aspects E8-9. Thus event-aspects may identify events at different abstraction levels.

The first level aspects E1-4 may be configured to identify sequences of simple events occurring directly within the base system 200. These sequences indicate the occurrence of first level complex events. The second level aspects E5-7 may monitor the first level event-aspects E1-4 and identify sequences of first level complex events which indicate the occurrence of second level complex events. Similarly, the third level aspects E8-9 may monitor the second level event-aspects E5-7 and identify sequences of second level complex events which indicate the occurrence of third level complex events. Clearly, embodiments of the CEP system may include more than three levels of events and may be extended indefinitely.

The event repository 160 is provided to facilitate the reuse of event aspects during development of the CEP. Code segments stored in the event repository 160 are accessible during development of new event aspects. It is noted particularly that the event repository 160 may be used in the development of different CEP systems or for the construction of new, often higher level, event aspects or response aspects to be added incrementally to a system.

It will be appreciated that providing this framework in an aspect-oriented context adds flexibility, variability, and greater modularity to event-based processing. The framework may support and codify a high-level design pattern for aspect systems, and may provide infrastructural support for aspects in appropriate applications.

A hierarchical structure of this type may reflect many real domains such as in banking, population tracking, medical monitoring, or the like. For example, the system may be applied to the auditing concern of a banking system. In particular, a layered approach to treating the concern of money laundering may be imposed over such a system, which is able to adapt to changes in legislation and tax law. Concerns such as auditing have complex terminology and events at several levels of abstraction. Often an intermediate level of a collection of suspicious red-flag events is normal. Thus, the creation of multiple on-line bank accounts of a similar type from the same IP address could be identified as a low level red-flag event. Low level red-flag events may then trigger deeper analysis to identify higher level red-flag complex events, indicating the occurrence of, for example smurfing, which is the creation of many small entities to avoid reporting currency exchanges, or kiting, which involves moving among multiple domain names in financial transactions to avoid detection.

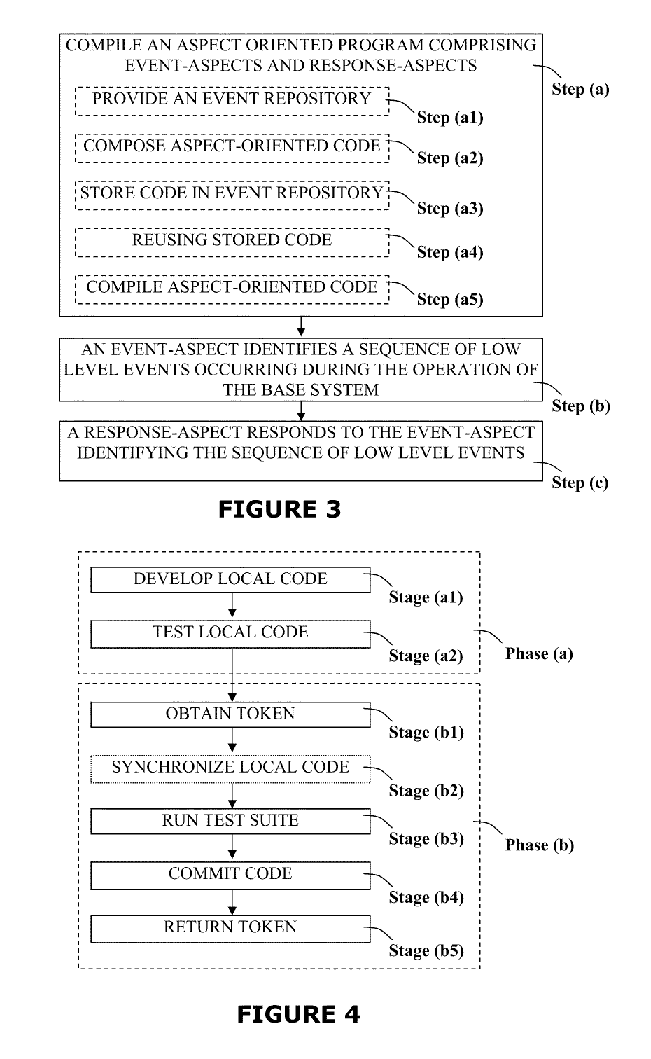

Referring now to FIG. 3, a flowchart is presented showing the steps of a method for identifying complex events according to embodiments of the CEP system. The method includes the following steps.
Step (a)—compiling an aspect-oriented program including at least one event-aspect and at least one response-aspect. Where the CEP system includes an event repository, this first step may include substeps selected from: step (a1)—providing the event repository, step (a2)—composing aspect-oriented code, step (a3)—storing in the event repository sections of code selected from event-aspects, step (a4)—retrieving sections of code for use in the compilation of other event-aspects or response aspects and step (a5)—compiling said aspect-oriented code.
Step (b)—an event-aspect identifying a sequence of simple events occurring during the operation of the base system.
Step (c)—a response-aspect responding to the event-aspect.

According to various embodiments of the method, higher level events may be detected by a hierarchically structured CEP system as described hereinabove.

According to a particular embodiment of the CEP system, a framework called HighspectJ provides a structured AspectJ-based solution for defining and utilizing high-level events. This framework may treat an event as a first-class object, and differentiate between the identification and the treatment of the event. HighspectJ may facilitate the definition of events into layers, with higher level events being defined in terms of lower level events. In addition, the event repository 160 may contain code segments of event aspects which serve as building blocks to facilitate the definition and reuse of high-level events and response aspects.

For clarity and so as to demonstrate how embodiments of the CEP system may be applied, an illustrative embodiment of the CEP system is described below. The particular illustrative embodiment applies a HighspectJ framework to the field of software development. It will be appreciated however that other embodiments of the CEP system may be applied to other fields, such as distributed information technology systems, banking systems, stock trading systems, software development systems, fraud detection systems, security systems, population monitoring systems, medical systems and the like.

The CEP system may be used to provide event-based support for software development in which a team of software developers work together to construct an integrated code. Each developer in the team develops and modifies code in a local workspace and once in a while commits the code into a shared code database. FIG. 4 shows a flowchart representing a typical development cycle for a software developer working in an extreme programming environment.

Embodiments of the invention are particularly suited to use with extreme programming or similar Agile methods. In such methodologies software is developed cyclically and regularly tested. Unit-tests are applied to each section of code as it is developed and a test-suite, containing all the unit-tests, is applied to the integrated code as each section of code is added to the code suite.

The development cycle includes a coding phase and an integration phase. During the coding phase—phase (a), a local code unit is developed—stage (a1) and then tested—stage (a2). During the integration phase—phase (b), the developer obtains an integration token—stage (b1), if necessary the local code unit is synchronized with the code database—stage (b2), the test-suite is run—stage (b3); if the test-suite passes, then code is committed to the code database—stage (b4) and finally the integration token is returned—stage (b5).

Note the integration token obtained in stage (b1) is a useful protocol for preventing more than one developer from integrating code at any one time. The synchronization of the local code, referred to in stage (b2), is necessary when other developers have made modifications to the shared code database, which demand the local code to be updated.

The above-described software development cycle may be supported by embodiments of the CEP system. Note that the actual behavior of the participant developers may not match the required specifications. For instance, the developer may try to commit without first executing the required tests or obtaining the integration token, or may forget to return the token after the commit takes place.

Using an embodiment of the CEP system, such common system pitfalls as well as other deviations may be identified by event-aspects which are configured to announce the occurrence in real-time. Corresponding response-aspects, operating on the event-aspects, may be configured to bring the deviations to the attention of the developer, to log them for further analysis and reflection, or perform some other action depending on the management strategy.

By way of example, a specific event-aspect known as the SuiteExecutionProblem is described which is configured to identify a complex event indicating an integration problem related to the test-suite execution of stage (b3). The event-aspect is based upon three underlying simple events: (i) execution of the test-suite, (ii) modification of the local code, and (iii) committing of the code to the code database.

The three simple events may be themselves represented by three low level event-aspects: (i) SuiteExecution, (ii) CodeModification, and (iii) Commit. By storing these low level event-aspects within the event repository, it is relatively easy to define higher level event-aspects such as the SuiteExecutionProblem event-aspect.

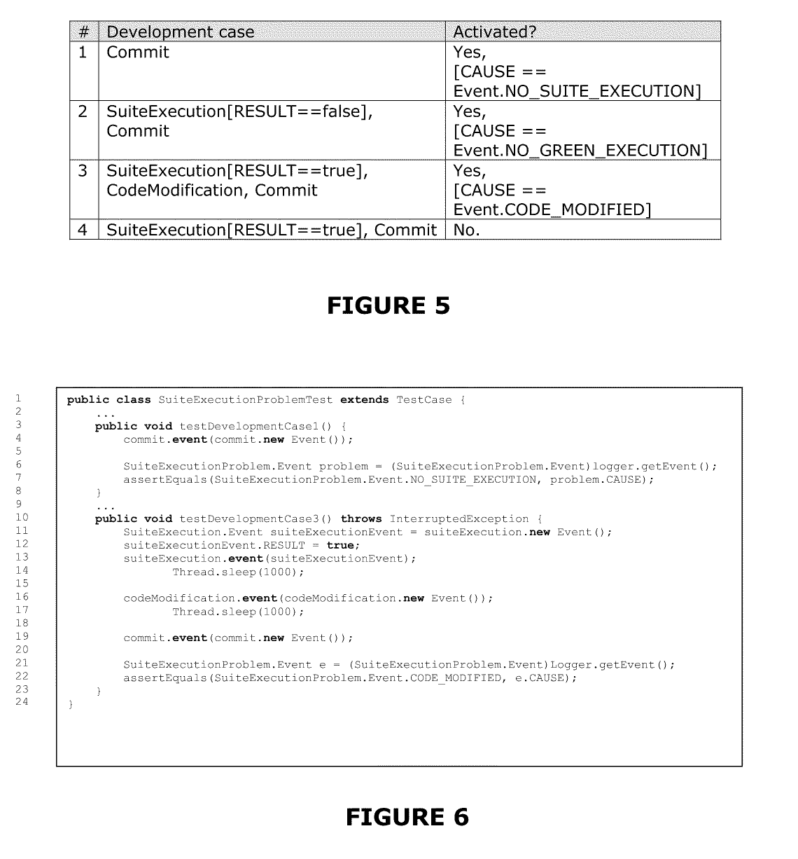

The event-aspect may be specified by a set of lower level event sequences; each sequence denotes a specific ordering of underlying events upon which the event aspect depends. For each event sequence, the specific state of its context variables is described, as well as whether the event-aspect should be activated. The specification of SuiteExecutionProblem is as outlined in FIG. 5.

In the first event sequence, the developer attempts to commit code without a prior execution of the test suite. When such an event sequence is identified, the event-aspect activates its event and also indicates the cause of the problem (via a context variable labeled CAUSE), that no test suite has been executed (NO_SUITE_EXECUTION).

In the second event sequence, the test suite is executed before the developer attempts to commit but contains failing tests. When the second event sequence is identified, the event-aspect again activates its event indicating that no successful test result has been received (NO_GREEN_EXECUTION).

In the third event sequence, the suite is executed successfully but code modification takes place afterwards, which may indicate a need for an additional suite execution. When the third event sequence is identified, the event is activated indicating that code has been modified since testing (CODE_MODIFIED).

The fourth event sequence relates to the protocol behavior where the developer conducts a successful suite execution and commits the code without further modification. Because this is the event sequence occurring during normal operation, no event is triggered in response to the fourth event sequence.

The implementation of the event-aspect may take place within a dedicated project (for example an Eclipse plug-in project with AspectJ support). Typically, the underlying events used by the event-aspect exist in the event repository and the first step is then to import events from the event repository into the project. Alternatively, the underlying events may themselves be implemented.

The framework of embodiments of the CEP system may facilitate Test-Driven Development (TDD) of event-aspects based on their specification. At each TDD step, a test method may be automatically generated for a specific event sequence and then the code within the event-aspect that passes the test is developed. For example JUnit methods for the first and third event sequences are presented in FIG. 6. In each test method an event sequence is simulated and then it is checked whether the post-condition meets the specification. The coding of each event sequence within the test method is straightforward; the activation of each of its lower-level events is simulated by calling the corresponding event-aspect's event(..) method (e.g., line 4).

If the event is specified to have a particular context (e.g., SuiteExecution in the third event sequence), then before calling the event(..) method, the context is set as appropriate (lines 11-12). Note the default time delay of one second between the events (lines 14,17) which may be required in order to query for timing relations between the events.

After simulating the event sequence, the post-condition is checked. The checking may be facilitated by a Logger aspect provided by the framework; the aspect may be requested to log activations of a particular event (in this example SuiteExecutionProblem) and is initialized before each test method using the JUnit setUp( ) method.

At the end of the simulation, the logged event is retrieved (lines 6,21) and checked for the expected context value. If the event was not activated, the Logger returns null and the test method fails.

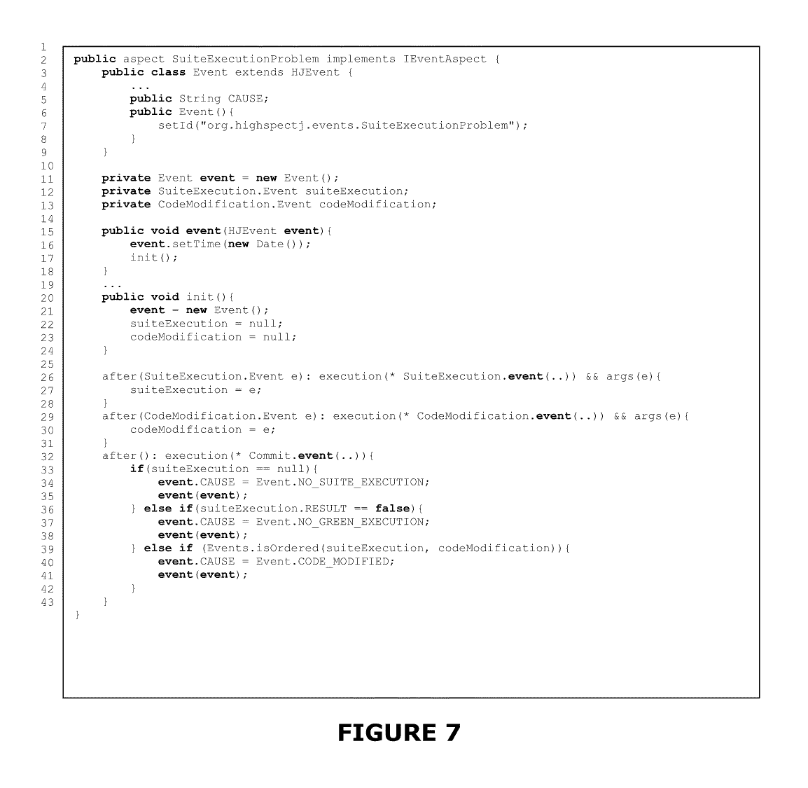

A SuiteExecutionProblem event-aspect satisfying the above-mentioned specification is presented in FIG. 7. This event aspect implements the interface IEventAspect, and contains a public inner class called Event representing the event that is identified by the event-aspect, extending the HJEvent class provided by the framework. Any event context exposed by the event aspect should be declared within the Event class as public fields. In our example, a single context field CAUSE is defined, representing the cause of the problem and additional corresponding constants, not shown in the listing. Note that this technique allows an event aspect to expose context data and terminology that is not defined in the underlying base system or in lower-level events, but which is needed for the task at hand.

The event(..) method (line 14) is part of the IEventAspect interface, and is called by the event aspect when an occurrence of the event is identified. The init( ) method (line 19), also part of the interface, may flush the event aspect's state, and is called upon whenever the event(..) method is activated. Consequently, the event aspect is prepared for a new event cycle. It is noted that such initialization is important where the event aspect is a singleton and common member fields are used in subsequent event cycles.

The core functionality of the event-aspect, which is to monitor underlying events and to call its event(..) method as appropriate, begins at line 25. The first two advices are directed towards saving the events reported by the SuiteExecution event-aspect and the CodeModification event-aspect. The third advice handles the logic applied upon occurrence of a Commit event, and depends upon the state of the underlying events saved in the event repository. When the event(..) method is called it is passed the report of the lower-level event with the appropriate context.

Note also the use of the is Ordered(..) method in line 38; this static utility, defined in the Events class of the framework, gets a set of events and returns TRUE if the given events are in their correct chronological order and FALSE otherwise. Here it is used to verify whether code modification took place after the test suite execution.

Note that both the event aspect and its JUnit test contain repeatable and systematic code segments, most of them derived from the specification. In this particular embodiment of the CEP system, these segments are generated automatically thereby increasing the reliability of the code.

The above-described event aspect is configured to identify one common deviation from the development cycle shown in FIG. 4. The event aspect has a structured specification which is transformed into concrete test cases. Note that the high-level SuiteExecutionProblem event aspect may itself be stored in the event repository and may be used by a corresponding response-aspect or in the construction of different higher level event-aspects.

For example, a manager may use the code of SuiteExecutionProblem events to define a corresponding response-aspect that will monitor activations of the event(..) method and take appropriate action according to the cause of the problem. A typical action would be to provide the developer with a notification in real-time, whenever the deviation occurs. A response aspect may, for example, create an object of type Message, typically including a textual message such as the terms ERROR, WARNING or the like as suits the management strategy. The message may be presented using the EventViewer.

Furthermore, the event-aspect may be used to define higher-level event-aspects. For instance, a high level event-aspect may be configured to identify complex events indicating sensitive stages in the development process. In one example an event-aspect known as the CongestedProcessProblems event-aspect may be activated when multiple events indicating process problems such as those indicated by the SuiteExecutionProblem event-aspect occur within a certain time interval.

As noted, the layered event architecture is appropriate for situations where the terminology of the concern treated by the aspect is far from that of the underlying system. Although we have identified many applications, including so-called nonfunctional concerns, where such a design is appropriate, below we describe just one, for reasons of space.

As one nonfunctional concern, the framework may be used to treat usability evaluation of user interfaces. Usability is defined as the extent to which a product can be used by specified users to achieve specified goals with effectiveness, efficiency, and satisfaction. One common method to evaluate the usability of a given system is automatic evaluation, where the usage of the UI by real users is automatically monitored, analyzed, and searched for usability problems. The potential of AOP for automatic usability evaluation is known, but an event-based version provides a reusable collection of complex usability events (both positive and negative), using terminology not relevant to the application itself. For example, using a complex series of buttons and GUI elements instead of a simpler direct possibility for the same task defines a potential visibility problem event (the simple solution is hard to find).

The scope of the present invention is defined by the appended claims and includes both combinations and sub combinations of the various features described hereinabove as well as variations and modifications thereof, which would occur to persons skilled in the art upon reading the foregoing description.

In the claims, the word “comprise”, and variations thereof such as “comprises”, “comprising” and the like indicate that the components listed are included, but not generally to the exclusion of other components.

What is claimed:

1. A complex event processing system comprising at least one storage medium containing code operable to identify complex events occurring in a base system, wherein said code is compiled from an aspect-oriented program.

2. The system of claim 1, wherein the code includes at least one event-aspect and at least one response-aspect.

3. The system of claim 2, wherein the event-aspect is configured to identify the occurrence of at least one event.

4. The system of claim 2, wherein the response-aspect is configured to operate upon the event-aspect.

5. The system of claim 3, wherein the response-aspect are configured to notify of the occurrence of the event.

6. The system of claim 1 further comprising an event repository for storing at least one section of code corresponding to at least one event-aspect.

7. The system of claim 6, wherein the code includes at least one event-aspect and at least one response-aspect.

8. The system of claim 7, wherein at least one event-aspect comprises at least one section of code retrieved from the event repository.

9. The system of claim 7, wherein at least one response-aspect comprises at least one section of code retrieved from the event repository.

10. The system of claim 1, wherein the base system is selected from a group consisting of: distributed information technology systems, banking systems, stock trading systems, software development systems, fraud detection systems, security systems, population monitoring systems and medical systems.

11. A method for identifying complex event occurring in a base system said method comprising the steps:
step (a)—compiling an aspect-oriented program comprising at least one event-aspect and at least one response-aspect;
step (b)—said event-aspect identifying a sequence of simple events occurring during the operation of said base system; and
step (c)—said response-aspect responding to the event-aspect identifying said sequence of simple events.

12. The method of claim 11, wherein step (a) includes the substeps:
step (a1)—providing an event repository for storing at least one section of code;
step (a2)—composing aspect-oriented code; and
step (a5)—compiling aspect-oriented code.

13. The method of claim 12, wherein step (a) further includes at least one of the additional substeps:
step (a3)—storing at least one section of said code in said event repository, and
step (a4)—using at least one section of code retrieved from said event repository in at least one of an event-aspect or a response-aspect.

14. The method of claim 12, wherein at least one response-aspect at least one section of code retrieved from at least one event-aspect in said event repository.

15. The method of claim 12, wherein at least one event-aspect at least one section of code retrieved from at least one said event-aspect from said event repository.
